(19) United States
(12) Patent Application Publication
(10) Pub. No.: US 2019/0219220 A1
(43) Pub. Date: Jul. 18, 2019

(54) SUPPORTING DEVICE

(71) Applicant: SHIH-CHUNG CHOU, TAOYUAN CITY (TW)

(72) Inventor: SHIH-CHUNG CHOU, TAOYUAN CITY (TW)

(21) Appl. No.: 15/869,391

(22) Filed: Jan. 12, 2018

(51) Int. Cl. F16M 11/12; F16M 11/28; G06F 1/16

(52) U.S. Cl. CPC F16M 11/12; F16M 11/28; F16M 2200/066; F16M 2200/044; G06F 1/1607

(57) ABSTRACT

A supporting device including: a fixing arm, a first elastic member, a interlock member, an operating arm, a carrying assembly, and a second elastic member. One end of the fixing arm is pivotally connected to the interlock member, the other end of the fixing arm is connected to one end of the first elastic member, and the other end of the first elastic member is connected to the interlock member. Two ends of the operating arm are respectively pivotally connected to the carrying assembly and the interlock member. Two ends of the second elastic member are respectively fixed to the carrying assembly and the fixing arm. When the carrying assembly is carries an object to be carried, the first elastic member and the second elastic member are respectively stretched.

### BACKGROUND OF THE INVENTION

### 1. Field of the Invention

The present disclosure relates to a supporting device; in particular, to a supporting device of a display.

### 2. Description of Related Art

Fixing methods for common displays, such as various types of screens or televisions can be roughly classified into two major categories, one of which is to directly fix the display to a desktop or to a base, and the base is directly disposed on the desktop; the other one of which is to mount the display on a supporting device (e.g. a supporting arm), and a user can adjust the supporting device to change the position of the display. However, the structures of the supporting devices for supporting the displays available on the market are complicated, and the production costs of the supporting devices are high, thus causing high price and low purchase intention. In this regard, the present disclosure provides a supporting device to overcome the aforementioned drawbacks.

### SUMMARY OF THE INVENTION

The main object of the present disclosure is to solve the drawbacks concerning the complicated structure of the supporting devices including a support arm and the high production cost thereof.

To resolve the above technical problems, the present disclosure provides a supporting device, which includes a fixing arm having two end portions opposite each other, and the two end portions being respectively defined as a fixing end portion and a pivoting end portion; an interlock member pivotally connected to the pivoting end portion, and the interlock member being rotatable with respect to the fixing arm by an external force; a first elastic member having one end fixed to the fixing end portion and another end fixed to the interlock member; a carrying assembly configured to carry an object to be carried; an operating arm having one end pivotally connected to the pivoting end portion through an interlock rod and another end fixed to the carrying assembly, wherein the interlock rod and the interlock member are fixed to each other; and a second elastic member having one end fixed to the carrying assembly and another end fixed to the fixing arm, wherein the second elastic member and the operating arm are disposed at different positions in the carrying assembly; wherein when the operating arm is rotated with respect to the fixing arm by the external force, the operating arm drives the interlock member to rotate with respect to the fixing arm through the interlock rod and the interlock member rotating with respect to the fixing arm stretches the first elastic member; wherein when the carrying assembly carries the object to be carried, the first elastic member and the second elastic member are respectively stretched, and wherein a stretching amount of the first elastic member and the second elastic member respectively stretched when the carrying assembly carries the object to be carried is greater than a stretching amount of the first elastic member and the second elastic member respectively stretched when the carrying assembly does not carry the object to be carried.

The advantage of the present disclosure is that the overall structure of the supporting device of the present disclosure is relatively simple, and the production cost thereof is relatively low compared to that of the existing supporting devices including a support arm for supporting the display.

For further understanding of the present disclosure, the following embodiments are provided along with illustrations to facilitate the disclosure of the present disclosure.

### BRIEF DESCRIPTION OF THE DRAWINGS

FIG. 1 and FIG. 2 are perspective views of a supporting device according to an embodiment of the present disclosure.

FIG. 3 and FIG. 4 are exploded views of the supporting device according to the embodiment of the present disclosure.

FIG 5 is a partially enlarged view of the supporting device according to the embodiment of the present disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In addition, for an easy instruction, similar reference numbers or symbols refer to elements alike.

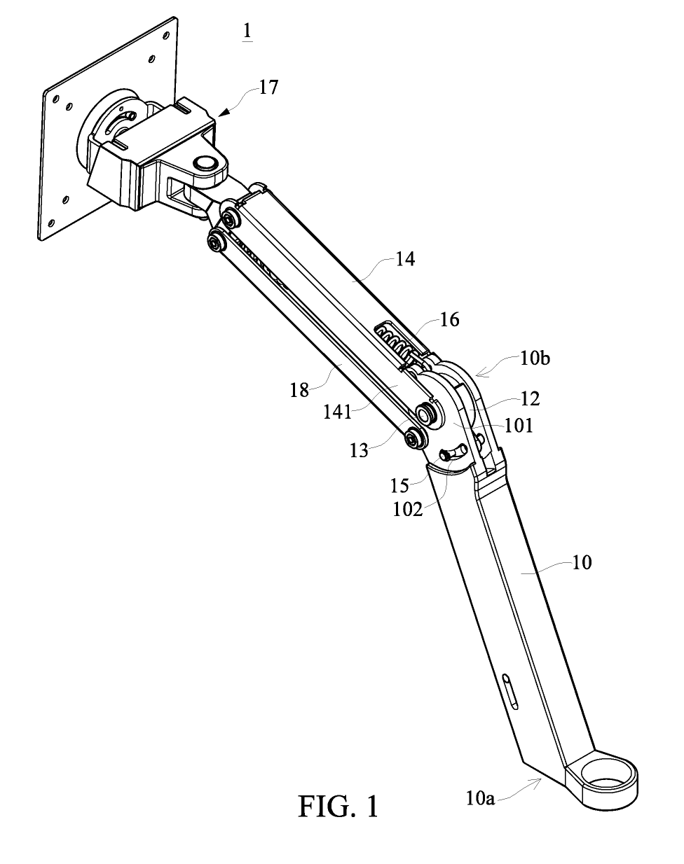

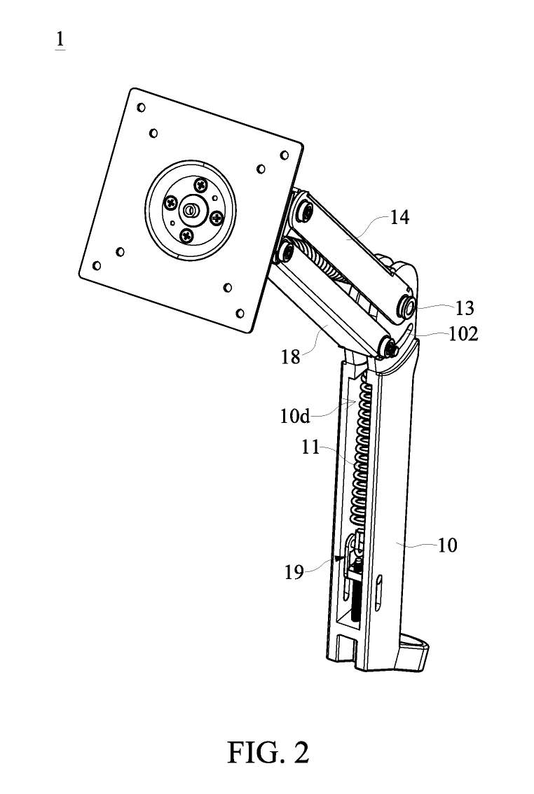

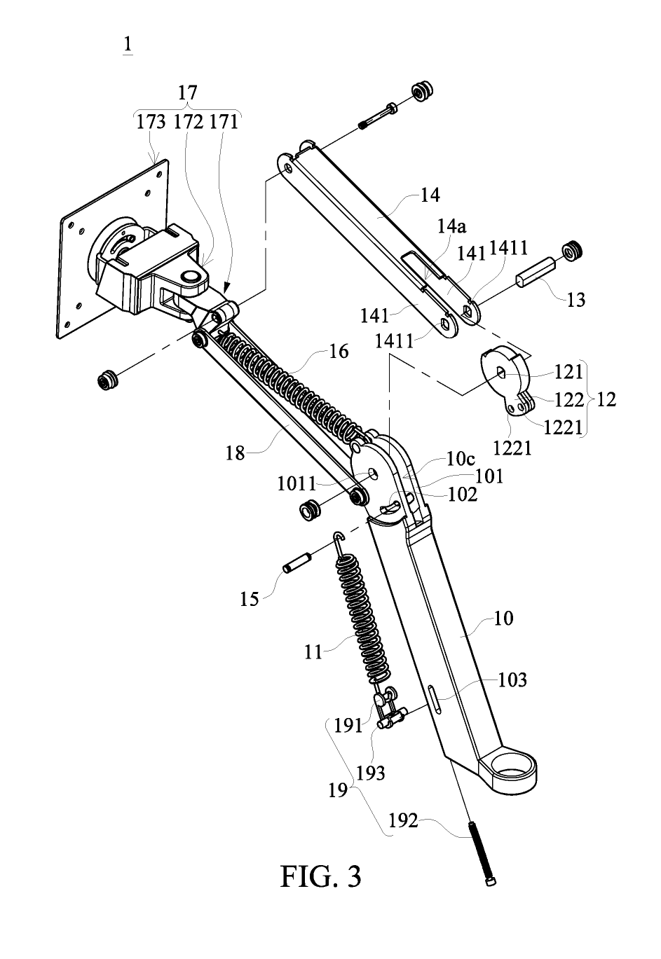

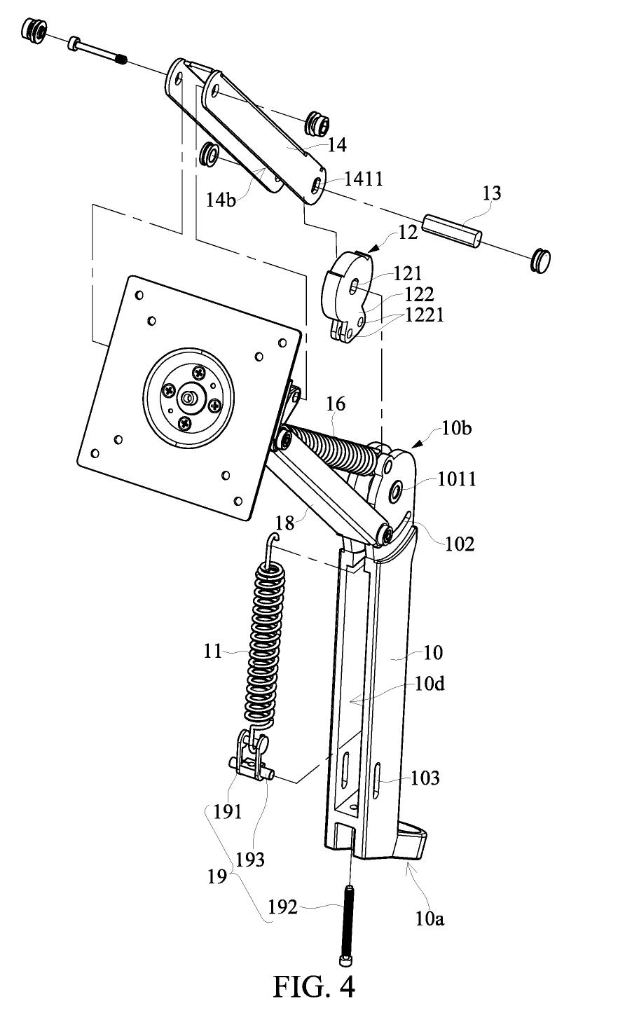

References are made to FIG. 1 to FIG. 4, in which FIG. 1 and FIG. 2 are perspective views of a supporting device according to an embodiment of the present disclosure, and FIG. 3 and FIG. 4 are exploded views of the supporting device according to the embodiment of the present disclosure. Referring to FIG. 1 and FIG. 2, the supporting device 1 includes a fixing arm 10, a first elastic member 11, an interlock member 12, an operating arm 14, a carrying assembly 17, and a second elastic member 16. One end of the fixing arm 10 is configured to be fixedly disposed on a fixing component, e.g. a desk, and another end of the fixing arm 10 is pivotally connected to the interlock member 12. One end of the first elastic member 11 is fixed to one end of the fixing arm 10, and the other end of the first elastic member 11 is pivotally connected to the interlock member 12. One end of the operating arm 14 is connected to the interlock member 12, and the other end of the operating arm 14 is connected to the carrying assembly 17. The carrying assembly 17 is configured to carry an object to be carried, such as a screen or a television of various types. One end of the second elastic member 16 is fixed to the carrying assembly 17, the second elastic member 16 and the operating arm 14 are disposed at different positions in the carrying assembly 17, and another end of the second elastic member 16 is fixed to one end of the fixing arm 10 which is provided with the interlock member 12. When the carrying assembly 17 carries the object to be carried, the first elastic member 11 and the second elastic member 16 are respectively stretched.

Referring to FIG. 3 and FIG. 4, in more detail, the fixing arm 10 has two end portions opposite each other, and the two end portions are respectively defined as a fixing end portion 10a and a pivoting end portion 10b. The fixing end portion 10a can be designed to have an auxiliary structure fixed to a desk according to requirements, which is not limited herein. The pivoting end portion 10b of the fixing arm 10 includes two sheet-shaped structures 101 which are disposed facing each other, and an accommodating groove 10c is formed between the two sheet-shaped structures 101. Each of the two sheet-shaped structures 101 has a corresponding through hole 1011, and the interlock member 12 has a fixing hole 121 corresponding to the two through holes 1011. The interlock member 12 can be pivotally connected to the pivoting end portion 10b through a interlock rod 13 corresponding in structure to the two through holes 1011 and the fixing hole 121, and the interlock member 12 pivotally connected to the pivoting end portion 10b is correspondingly located in the accommodating groove 10c. Accordingly, the interlock member 12 can rotate around the interlock rod 13 in the accommodating groove 10c with respect to the two sheet-shaped structures 101.

One end of the operating arm 14 connected to the pivoting end portion 10b includes two sheet-body structures 141 which are disposed facing each other, and an avoiding groove 14a is formed between the two sheet-body structures 141. Each of the two sheet-body structures 141 has a corresponding perforating hole 1411, and the operating arm 14 can be pivotally connected to the pivoting end portion 10b through an interlock rod 13 corresponding in structure to the two perforating holes 1411. In other words, the two sheet-body structures 141 of the operating arm 14 can be correspondingly disposed outside the two sheet-shaped structures 101 of the fixing arm 10, and the interlock rod 13 can correspondingly pass through the two perforating holes 1411 of the operating arm 14, the two through holes 1011 of the fixing arm 10, and the fixing hole 121 of the interlock member 12. Therefore, the operating arm 14 and the interlock member 12 can be jointly and pivotally connected to the pivoting end portion 10b of the fixing arm 10 through the interlock rod 13. It should be noted that the shape of the fixing hole 121 of the interlock member 12, the shape of the two perforating holes 1411 of the operating arm 14, and the shape of the interlock rod 13 correspond to each other. When the interlock rod 13 passes through the fixing hole 121 and the perforating holes 1411, the interlock rod 13 is fixed to the interlock member 12 and the operating arm 14. That is, when the operating arm 14 moves with respect to the fixing arm 10 by an external force, the interlock rod 13 is driven by the operating arm 14 to move synchronously, and the interlock member 12 is driven by the interlock rod 13 to move synchronously. The diameter of each of the through holes 1011 of the fixing arm 10 is slightly greater than the largest outer diameter of the interlock rod 13, and the interlock rod 13 can rotate with respect to the sidewalls of the through holes 1011. In other words, when the operating arm 14 is subjected to the external force, the operating arm 14, the interlock rod 13, and the interlock member 12 are simultaneously rotated with respect to the fixing arm 10.

Each of the two sheet-shaped structures 101 of the fixing arm 10 has an arc-shaped limiting groove 102 corresponding to one another. The interlock member 12 is provided with a limiting component 15, and a portion of the limiting component 15 is correspondingly located in the arc-shaped limiting groove 102. When the interlock member 12 is driven to rotate with respect to the pivoting end portion 10b, the portion of the limiting component 15 correspondingly moves along the arc-shaped limiting groove 102. The rotation of the interlock member 12 with respect to the pivoting end portion 10b is limited by the limiting component 15 and the arc-shaped limiting groove 102. In other words, the rotation range of the operating arm 14 with respect to the fixing arm 10 is limited to a length of the arc-shaped limiting groove 102. In another embodiment of the present disclosure, the limiting component 15 can also be a structure integrally formed with the interlock member 12.

One end of the first elastic member 11 is fixedly disposed on the limiting component 15, and the other end of the first elastic member 11 is fixedly disposed on the fixing end portion 10a of the fixing arm 10. In practical applications, the fixing arm 10 has another accommodating groove 10d concavely formed on one side thereof, and the first elastic member 11 can be correspondingly disposed in the accommodating groove 10d. When the operating arm 14 is driven by the external force to rotate the interlock member 12 with respect to the pivoting end portion 10b, the limiting component 15 fixed to the interlock member 12 is rotated along with the interlock member 12, and one end of the first elastic member 11 fixed to the limiting component 15 is stretched. The distance between the positions of the limiting component 15 and the first elastic member 11 on the fixing end portion 10a is greater than an original length of the first elastic member 11 not subject to an external force. That is, when the carrying assembly 17 does not carry the object to be carried, and two ends of the first elastic member 11 are respectively fixed to the limiting component 15 and the fixing end portion 10a, the first elastic member 11 is in a stretched state.

In practical applications, the interlock member 12 can further include an interlock portion 122, a position of the interlock portion 122 corresponding to the arc-shaped limiting groove 102 is formed with two interlock fixing holes 1221, and the limiting component 15 is fixed to the interlock member 12 by being engaged with one of the interlock fixing holes 1221. The distances between the two interlock fixing holes 1221 and the position where the first elastic member 11 is fixed to are different from each other. That is, when the carrying assembly 17 is not carrying the object to be carried, a stretching amount of the first elastic member 11 stretched when the limiting component 15 is fixed to the interlock member 12 by being engaged with one of the interlock fixing holes 1221 is different from a stretching amount of the first elastic member 11 stretched when the limiting component 15 is fixed to the interlock member 12 by being engaged with the other one of the interlock fixing holes 1221. Therefore, an assembler can adjust the stretching amount of the first elastic member 11 stretched when the first elastic member 11 is mounted on the fixing arm 10 according to requirements. It is worth mentioning that the assembler can change the angles of an auxiliary arm 18 and the operating arm 14 with respect to the fixing arm 10 by disposing the first elastic member 11 and the limiting component 15 in different interlock fixing holes 1221. In addition, the number of the interlock fixing holes 1221 can be changed according to requirements, and is not limited to two as described in the present embodiment.

Two ends of the second elastic member 16 are respectively fixed to the pivoting end portion 10b and the carrying assembly 17. The position of the second elastic member 16 in the pivoting end portion 10b is different from the position of the interlock rod 13 and the position of the arc-shaped limiting groove 102. The positions of the second elastic member 16 and that of the operating arm 14 in the carrying assembly 17 are different. In practical applications, when the carrying assembly 17 does not carry the object to be carried, the second elastic member 16 is in a stretched state. In addition, the operating arm 14 has a recessed groove 14b formed in one side thereof, and the second elastic member 16 can be correspondingly located in the recessed groove 14b. The supporting device 1 further includes an auxiliary arm 18. One end of the auxiliary arm 18 and the second elastic member 16 are jointly connected to the carrying assembly 17, and the other end of the auxiliary arm 18 is pivotally connected to the fixing arm 10. When the carrying assembly 17 is operated to move with respect to the fixing arm 10, the operating arm 14 is rotated with respect to the fixing arm 10 with the interlock rod 13 being the pivot, and the auxiliary arm 18 is rotated with respect to the fixing arm 10 with the portion of the auxiliary arm 18 pivotally connected to the pivoting end portion 10b being the pivot.

In practical applications, the carrying assembly 17 can include a pivoting structure 171, a steering structure 172 and a connecting structure 173. The operating arm 14 and the auxiliary arm 18 are connected to the pivoting structure 171, the pivoting structure 171 and the steering structure 172 are connected with each other, and a side of the steering structure 172 opposite the pivoting structure 171 is connected to the connecting structure 173. The connecting structure 173 is configured to fix the object to be carried, and the steering structure 172 is configured to enable the connecting structure 173 to rotate with respect to the pivoting structure 171. It should be noted that the carrying assembly 17 can have different structures according to requirements, which is not limited to that described in the present embodiment.

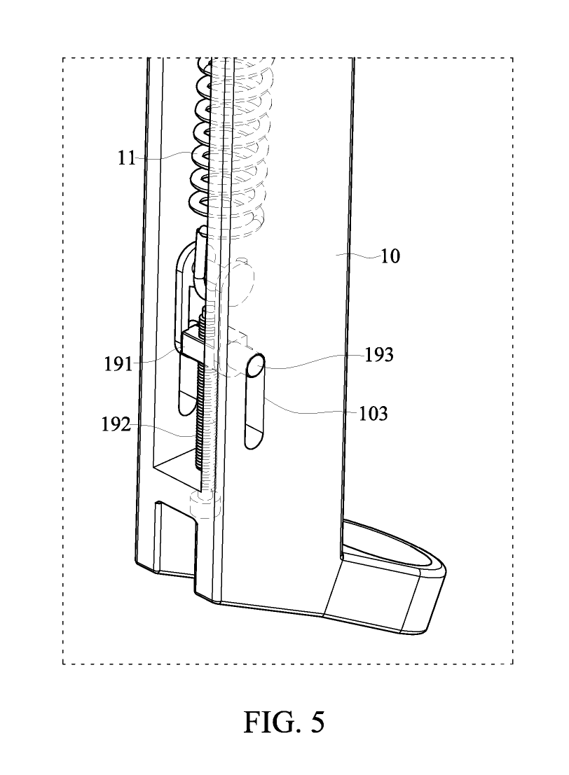

Referring to FIG. 3 to FIG. 5, in another embodiment of the present disclosure, the supporting device 1 further includes an adjustment assembly 19 disposed in the accommodating groove 10d of the fixing arm 10, and one end of the first elastic member 11 fixed to the fixing end portion 10a is connected to the adjustment assembly 19. The adjustment assembly 19 can be operated to change the stretching amount of the first elastic member 11 when the carrying assembly 17 does not carry the object to be carried. For example, the adjustment assembly 19 includes a movable member 191 and a screw 192, one end of the first elastic member 11 is fixed to the movable member 191, the movable member 191 and the screw 192 are connected to each other, and one end of the screw 192 is exposed at the fixing end portion 10a, in which the end of the screw 192 exposed at the fixing end portion 10a is capable of being operated in a manner such that the movable member 191 moves with respect to the screw 192 so as to adjust the stretching amount of the first elastic member 11 when the carrying assembly 17 does not carry the object to be carried.

It should be noted that the fixing arm 10 has a guiding groove 103 formed in the fixing end portion 10a, and the movable member 191 correspondingly includes a guiding component 193. When the adjustment assembly 19 is disposed in the accommodating groove 10d, a portion of the guiding component 193 is correspondingly exposed at the guiding groove 103. When the screw 192 is operated and the movable member 191 is driven to move with respect to the fixing end portion 10a, a portion of the guiding component 193 moves along the guiding groove 103. That is, the supporting device 1 can limit a moving amount of the movable member 191 with respect to the fixing end portion 10a through the limitation of the guiding component 193 by the guiding groove 103 so as to restrain the amount of adjustment made by a user when the user tries to adjust the stretching amount of the first elastic member 11 through the screw 192. In addition, with the limitation of the guiding component 193 by the guiding groove 103, the supporting device 1 can also limit the movement of the movable member 191 to linear motion when the movable member 191 is driven by the screw 192 and moves with respect to the fixing end portion 10a so as to ensure that the movable member 191 stretches the first elastic member 11 along a linear path.

The descriptions illustrated supra set one simply the preferred embodiment of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

1. A supporting device, comprising:
a fixing arm having two end portions opposite each other, and the two end portions being respectively defined as a fixing end portion and a pivoting end portion;
an interlock member pivotally connected to the pivoting end portion, and the interlock member being rotatable with respect to the fixing arm by an external force;
a first elastic member having two opposite ends, wherein one of the two ends of the first elastic member is fixed to the fixing end portion and the other of the two ends of the first elastic member is fixed to the interlock member;
a carrying assembly configured to carry an object to be carried;
an operating arm having two opposite ends wherein one of the two ends of the operating arm is pivotally connected to the pivoting end portion through an interlock rod and the other of the two ends of the operating arm is fixed to the carrying assembly, wherein the interlock rod and the interlock member are fixed to each other; and
a second elastic member having two opposite ends, wherein one of the two ends of the second elastic member is fixed to the carrying assembly and the other of the two ends of the second elastic member is fixed to the fixing arm, wherein the second elastic member and the operating arm are disposed at different positions in the carrying assembly;
wherein when the operating arm is rotated with respect to the fixing arm by the external force, the operating arm drives the interlock member to rotate with respect to the fixing arm through the interlock rod and the interlock member rotating with respect to the fixing arm stretches the first elastic member;
wherein when the carrying assembly carries the object to be carried, the first elastic member and the second elastic member are respectively stretched to have a first stretching amount, and when the carrying assembly does not carry the object to be carried, the first elastic member and the second elastic member are respectively stretched to have a second stretching amount; wherein the first stretching amount is greater than a second stretching amount.

2. The supporting device according to claim 1, wherein the fixing arm has at least one arc-shaped limiting groove formed in the pivoting end portion, the interlock member includes a limiting component, and a portion of the limiting component is located in the arc-shaped limiting groove, wherein when the interlock member is rotated with respect to the fixing arm, the limiting component moves along the arc-shaped limiting groove.

3. The supporting device according to claim 2, wherein the interlock member has at least two interlock fixing holes, one end of the first elastic member is fixed to the interlock member through the limiting component that corresponds in structure to one of the interlock fixing holes, wherein when the carrying assembly does not carry the object to be carried, a stretching amount of the first elastic member stretched when the limiting component is fixed to the interlock member by being engaged with one of the two interlock fixing holes is different from a stretching amount of the first elastic member stretched when the limiting component is fixed to the interlock member by being engaged with the other of the two interlock fixing holes.

4. The supporting device according to claim 1, further comprising an adjustment assembly including a movable member and a screw, wherein one end of the first elastic member is fixed to the movable member, the movable member and the screw are connected to each other, and an end of the screw is exposed at the fixing end portion, wherein the end of the screw exposed at the fixing end portion is capable of being operated in a manner such that the movable member moves with respect to the screw so as to adjust the stretching amount of the first elastic member.

5. The supporting device according to claim 4, wherein the fixing arm has a guiding groove formed in the fixing end portion, the movable member includes a guiding component, and a portion of the guiding component is exposed at the guiding groove, wherein when the screw is operated and the movable member moves with respect to the screw, a portion of the guiding component moves along the guiding groove.

6. The supporting device according to claim 1, further comprising an auxiliary arm that has two opposite ends, wherein one of the two ends of the auxiliary arm and the second elastic member are jointly fixed to the carrying assembly, and the other of the two ends of the auxiliary arm is pivotally connected to the fixing arm.
